(19) United States
(12) Patent Application Publication
(10) Pub. No.: US 2007/0018475 A1
(43) Pub. Date: Jan. 25, 2007

(54) Deployable pad for vehicle bumper of tail gate protection

(76) Inventors: Glenn Mack McGinnis, Lutz, FL (US); John Franklin Coyne, Mechanicsburg, PA (US)

Correspondence Address: Glenn M. McGinnis, 4902 Mirabella Place, Lutz, FL, 33558, US

(21) Appl. No.: 11/184,663

(22) Filed: Jul. 20, 2005

(51) Int. Cl. B60R 13/01; B62D 33/00

(52) U.S. Cl. 296/39.1

(57) ABSTRACT

The deployable pad described herein protects vehicle painted and decorative rear bumpers, and downward opening rear tailgates on certain type of vehicles from accidental damage when cargo is loaded or off-loaded. The deployable device folds flat onto the cargo area floor, a cargo area liner or the trunk floor when not in use. This invention provides protection when needed yet is stored out of sight when not in use and thereby does not detract from the intended exterior design and finish of the vehicle. The device can be attached to the cargo area itself either with mechanical fasteners, adhesives, 2-sided tape or hook and loop fasteners. The cargo area in question may be an automobile trunk, or the cargo area of a SUV, station wagon or panel van.

### BACKGROUND OF THE INVENTION

1. Technical Field of the Invention

The present invention describes a device to protect vehicle rear bumpers or downward opening tailgate surfaces from damage or scratching inflicted when cargo, persons, pets or other objects being loaded or off-loaded scrape across the top or rear surface of the bumper or the threshold between the cargo area and the bumper.

2. Description of Related Art

The usage of specialized vehicles such as Sport Utility Vehicles (SUVs) hatch back sedans, upper scale trucks, and crossover vehicles which are seeking to fill the gap between autos and SUVs is growing at a rapid pace.

Many of these vehicles are decorated in the “European style” which includes painting bumper surfaces to match the exterior color of the vehicle. The duality of roles fulfilled by these vehicles include their use as light to medium duty cartage and hauling as well hauling traditional family and travel items in the rear cargo area. The fulfillment of this role necessitates moving diverse types of cargo and luggage across the painted rear bumper of these vehicles and thereby increasing the probability of superficial yet unsightly damage in the form of dents, scrapes and scratches. While vehicle owners may exercise extreme caution when handling items there is no guaranteeing that the average bellman or airport curbside luggage handler isn't having a bad day. The cost of repainting a rear bumper with some of the more elaborate 3 coat metallic finishes can approach $400 for repainting. Additionally, repairing any gouges or tears in the plastic skins used for bumpers can add hundreds of dollars to the repair cost.

Likewise, most automobiles also utilize the European style of decorated rear bumpers. These implementations are just as exposed to damage as SUVs and can be protected by the same or similar embodiments offered for utility vehicles.

There exists inventions and devices in place today to that are intended to protect the finish and appearance of vehicle bumpers. These include paint sealants and waxes, plastic films, covers and pads.

There are disadvantages and drawbacks associated with each of the available solutions. While the various paint sealants and waxes available do provide protection for automotive finishes they are unable to mitigate the physical damage a large, heavy object can impart as it is dragged across a decorated bumper. Plastic films manufactured from PPF plastic and other plastics are available for the flat top portions of some bumpers. While these films provide limited protection for the top of the bumper they do not cover the rest of the bumper including the vulnerable areas such as the curved edge adjoining the top of the bumper. Films are relatively expensive and their installation is labor intensive. Adhesive pads used to provide bumper protection are semi-permanently affixed and detract from the overall vehicle appearance. Metal bumper covers again are permanently affixed and dramatically alter and impact the overall vehicle appearance.

Likewise, there exists a multitude of inventions that are intended to protect bumpers from parking lot damage. These devices are permanently attached to the intended vehicle or are temporarily affixed when the vehicle is parked in a vulnerable position.

There is a need in the art for providing an easily deployable method to protect painted, decorative and chrome plated rear vehicle bumpers, automobile trunk sills and downward opening tailgate interiors from scrapes and other damage when cargo is being loaded or off-loaded in a manner that necessitates said cargo being passed over the painted, decorative or chrome plated rear bumper or tailgate surfaces that does not alter the permanent overall appearance of the vehicle.

Furthermore, there exists a need to integrate the functionality of the deployable rear bumper protection pad and tailgate protection pad into the protection offered by optional, after-market cargo area liners, which are a popular accessory for all of the types of motor vehicles discussed previously.

### SUMMARY OF THE INVENTION

The deployable pad for vehicle bumper and tailgate protection is comprised of a thin layer of flexible rubber, plastic sheet or carpet, or a laminated combination of the aforementioned materials that can be embedded within the design of a cargo area liner, attached to an existing cargo area liner, attached to the vehicles cargo area floor, attached to the interior of a downward opening tailgate or attached to the trunk sill, inner rear trunk wall or the trunk floor of an automobile. When the deployable pad for vehicle bumper and tailgate protection is attached to a cargo area liner it may be attached through the use a pre-glued plastic living hinge, which is part of the pad. It can also be attached by using double-sided tape or other mechanical fasteners. The deployable pad for vehicle bumper and tailgate protection can be attached to a vehicle cargo area floor or interior trunk surface by adhesive means or mechanical fasteners. The actual method of attachment will vary by vehicle type due to design and material differences. The basic shape of the deployable pad for vehicle bumper and tailgate protection also varies based upon vehicle design attributes. In general a rectangular shape can be utilized. However, in some instances a rectangular shape with the appropriate sides being curved will better fit cargo area floors with curved boundaries.

The methods of manufacture for deployable pad for vehicle bumper and tailgate protection include:

adding an extra flap to existing after market cargo area liners

altering the manufacturing process for cargo area liners to include an attached and deployable pad for vehicle bumper and tailgate protection

providing custom trimmed and fitted pads for specific manufactures, year of manufacture and model

providing a one size fits all or many product that can be trimmed to suit with common household items.

Care must be exercised during material selection in order to ensure that the resultant apparatus will perform in a satisfactory manner throughout the range of environmental factors encountered by automotive applications. This would include but is not limited to abrasion resistance, cold cracking resistance, Ultra Violet light, flexibility and adhesive longevity.

The deployable pads used for rear bumper protection and the deployable pads used for tailgate protection are similar embodiments. However, the implementation and nuances of the embodiment's usages requires that they be described within this invention. There are claims and drawings included within this patent to describe those requirements.

### BRIEF DESCRIPTION OF THE DRAWINGS

FIG. 1 is a perspective drawing of a top view of a deployable pad for vehicle bumper and tailgate protection.

FIG. 1A is a perspective drawing of a top view of a deployable pad for vehicle bumper and tailgate protection attached to a cargo area liner.

FIG. 1B is a perspective view of an integrated cargo area liner and deployable pad for vehicle bumper and tailgate protection.

FIG. 2 is a perspective view of a deployable pad for vehicle bumper and tailgate protection trimmed to fit the curvature of a vehicle;

FIG. 2A is a top view of a deployable pad for vehicle bumper and tailgate protection positioned in the cargo area of a vehicle;

FIG. 3 is a perspective view of a deployable pad for vehicle bumper and tailgate protection attached to a cargo area liner;

FIG. 3A is a cross section view from the side of a vehicle with a deployable pad for vehicle bumper and tailgate protection attached to a cargo area liner;

FIG. 4 is a perspective view of a deployable pad for vehicle bumper and tailgate protection attached to a cargo area liner in the deployed position;

FIG. 4A is a cross section view from the side of a vehicle with a deployable pad for vehicle bumper and tailgate protection attached to a cargo area liner in the deployed position;

FIG. 5 is a perspective view of a deployable pad for vehicle bumper and tailgate protection attached to a cargo area liner in the deployed position with cargo loaded into the cargo area;

FIG. 5A is a cross section view from the side of a vehicle with a deployable pad for vehicle bumper and tailgate protection attached to a cargo area liner in the deployed position with cargo loaded into the cargo area;

FIG. 6 is a perspective view of a deployable pad for vehicle bumper and tailgate protection attached to a cargo area liner in the retracted position with cargo loaded into the cargo area;

FIG. 6A is a cross section view from the side of a vehicle with a deployable pad for vehicle bumper and tailgate protection attached to a cargo area liner in the retracted position with cargo loaded into the cargo area;

FIG. 7 is a perspective drawing of a vehicle equipped with an opening tailgate and a cargo area liner;

FIG. 7A is a cross section view of a vehicle equipped with an opening tailgate and a cargo area liner;

FIG. 8 is a cross section view of a vehicle equipped with an opening tailgate and a cargo area liner equipped with a deployable pad for vehicle bumper and tailgate protection in the retracted position;

FIG. 8A is a cross section view of a vehicle equipped with a downward opening tailgate and a cargo area liner equipped with a deployable pad for vehicle bumper and tailgate protection in the deployed position;

FIG. 9 is a cross section view of a vehicle equipped with an opening tailgate that is equipped with a deployable pad for vehicle bumper and tailgate protection in the retracted position;

FIG. 9A is a cross section view of a vehicle equipped with an opening tailgate equipped with a deployable pad for vehicle bumper and tailgate protection in the deployed position;

FIG. 10 is a perspective drawing of a deployable pad for vehicle bumper and tailgate protection with cutouts to avoid inducing false backup obstacle detection system alarms;

FIG. 11 is a perspective drawing of a deployable pad for vehicle bumper and tailgate protection with added protection to avoid trailer tongue damage;

FIG. 12 is a perspective drawing of a semi-rigid deployable pad for vehicle bumper and tailgate protection attached to the trunk sill of an automobile;

FIG. 12A is a perspective drawing of a flexible deployable pad for vehicle bumper and tailgate protection attached to the trunk sill of an automobile;

FIG. 13 is a cross sectional view depicting variable deployable pad cross sectional thickness

FIG. 14 is a perspective drawing of a deployable pad for bumper protection shaped to fit a curved automobile trunk sill.

FIG. 14A is a cross sectional view of a deployable pad for bumper protection shaped to fit a curved automobile trunk sill.

FIG. 14B is a top view of an automobile trunk with a deployable pad for bumper protection shaped to fit a curved automobile trunk sill affixed.

FIG. 14C is a cross sectional view of a curved trunk sill with a deployed bumper protection pad.

FIG. 14D is a cross sectional view of a curved trunk sill with a retracted bumper protection pad.

FIG. 15 is a top view of a deployable pad that can be attached to the receiving vehicle by using a pair of connecting straps.

FIG. 15A is a cross sectional view of a deployed, strap attached protection pad in a typical automotive trunk implementation.

FIG. 15B is a cross sectional view of a retracted, strap attached protection pad in a typical automotive trunk implementation.

FIG. 16A is a cross sectional view of a deployed, strap attached protection pad in a typical SUV cargo area implementation.

FIG. 16B is a cross sectional view of a retracted, strap attached protection pad in a typical SUV cargo area implementation.

FIG. 17A is a cross section illustrating how a strap mounted protection pad would attach to any vehicle type when using double-sided tape.

FIG. 17B is a cross section illustrating how a strap mounted protection pad would attach to any vehicle type when using hoop and loop fasteners.

FIG. 17C is a cross section illustrating how a strap mounted protection pad would attach to any vehicle type when using mechanical fasteners.

### DETAILED DESCRIPTION OF THE DRAWINGS

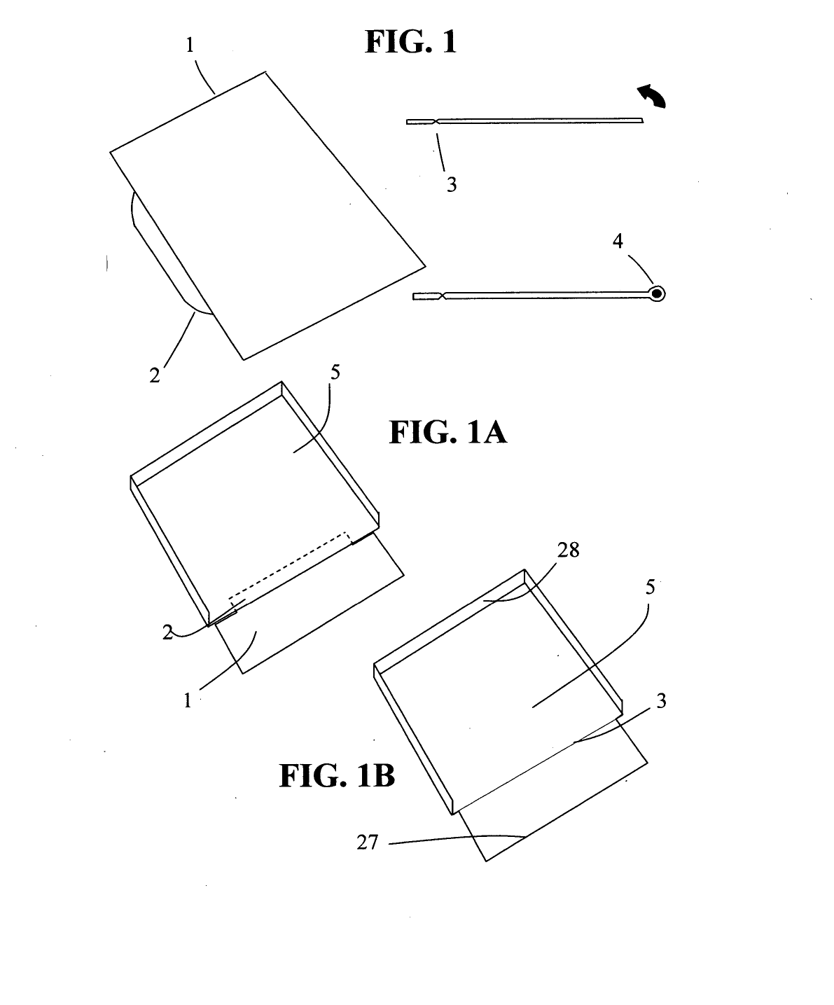

FIG. 1 illustrates the general shape and form of the version of a directly attachable deployable pad for vehicle bumper and tailgate protection (1) that can be attached to an existing cargo area liner, the floor of the cargo area, an inner surface of an automobile trunk or a deployable downward opening tailgate. The exact size of a pad is defined by the width of the cargo area opening and the depth required to adequately protect the bumper or opened tailgate assembly. In certain instances it is necessary to curve one or more sides of the deployable pad for vehicle bumper and tailgate protection to match the curvature of the receiving vehicle.

The deployable pad for vehicle bumper and tailgate protection (1) in general is of a rectangular shape and when not constructed as a portion of a cargo area liner contains a mounting strip (2), which is attached to the existing cargo area liner, cargo area floor or downward opening tailgate. Fastening methods for attaching the mounting strip (2) include but are not limited to: double sided tape, general adhesives and mechanical fasteners. A hinging mechanism (3) is required to allow the rectangular portion of the deployable pad for vehicle bumper and tailgate protection to pivot from the retracted position to the deployed position and visa versa. The hinging mechanism can be any of a multitude of methods including: a scribed hinging line if plastics such as polypropylene are used, attachable plastic hinge, living hinge molded within the pad assembly or heavy-duty tape or cloth.

The pad portion of the deployable pad for vehicle bumper and tailgate protection (1) must be pliable or, flexible, somewhat resistant to chemicals, Ultra Violet light resistant and must retain its' flexibility when exposed to cold winter temperatures. A pad having a low friction coefficient is desirable as it would;
not impede the progress of an item being loaded or off-loaded that comes in contact with the pad
diminish the tendency of a moving object to move the deployed pad
be less subjected to wear and tear

A minor embodiment of the deployable pad for vehicle bumper and tailgate protection consists of adding weight (4) to the free end to reduce flutter and flapping if it is necessary to drive the vehicle with the cargo area door or tailgate opened and the deployable pad for vehicle bumper and tailgate protection in a deployed position. Additional weight can be added by embedding it within the material itself, gluing the weight to the pad or making a small cavity that can be filled with water or other ballast when additional weight is desired.

FIG. 1A illustrates how a deployable pad for vehicle bumper and tailgate protection (1) can be attached to an existing cargo area liner (5). The mounting strip (2) can be adhered to the bottom of the cargo area liner as shown or it may be attached to the front vertical surface if the cargo area liner if it is so equipped.

FIG. 1B Illustrates an integrated embodiment of the deployable pad for vehicle bumper and tailgate protection and a removable cargo area liner (5). This embodiment utilizes an embedded live hinge (3) and yields a single device that can be easily installed and removed. An additional advantage afforded by this embodiment is a smooth, unbroken surface from the outside edge of the deployable pad portion of the integrated device (27) to the back wall of the device (28). The seamless device is especially beneficial for the loading and unloading of wheeled vehicles such as baby carriages and wheel chairs.

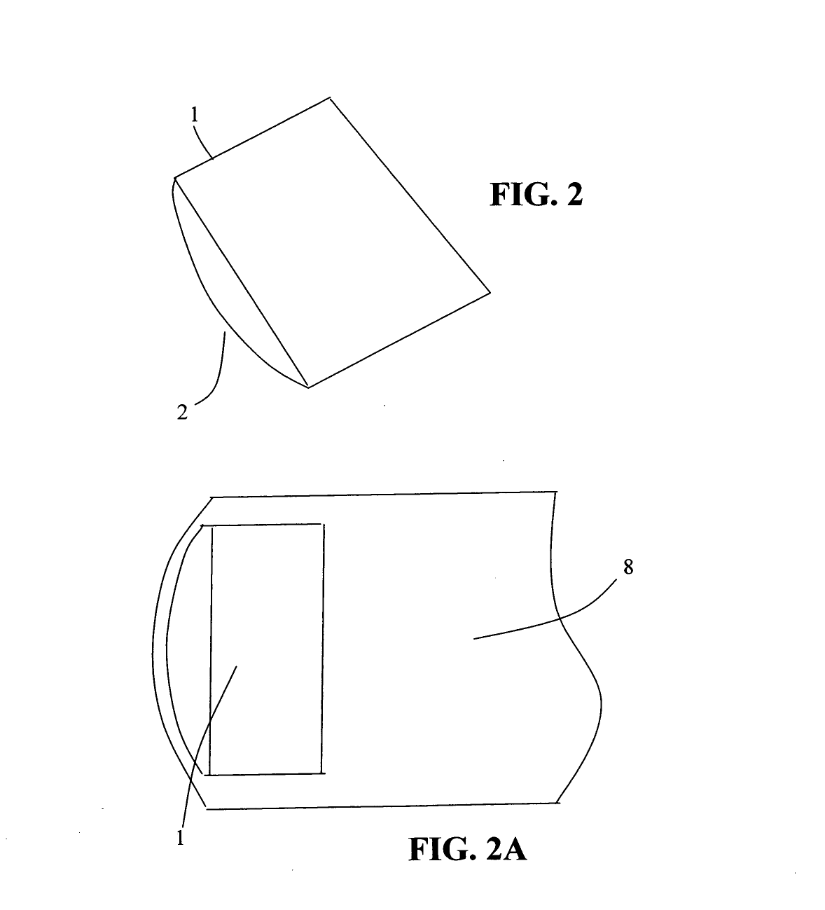

FIG. 2 shows a deployable pad for vehicle bumper and tailgate protection (1) that has been trimmed to fit the cargo area floor curvature (2) of a sample vehicle.

FIG. 2A illustrates how the trimmed deployable pad for vehicle bumper and tailgate protection (1) would be positioned on the cargo area floor (8).

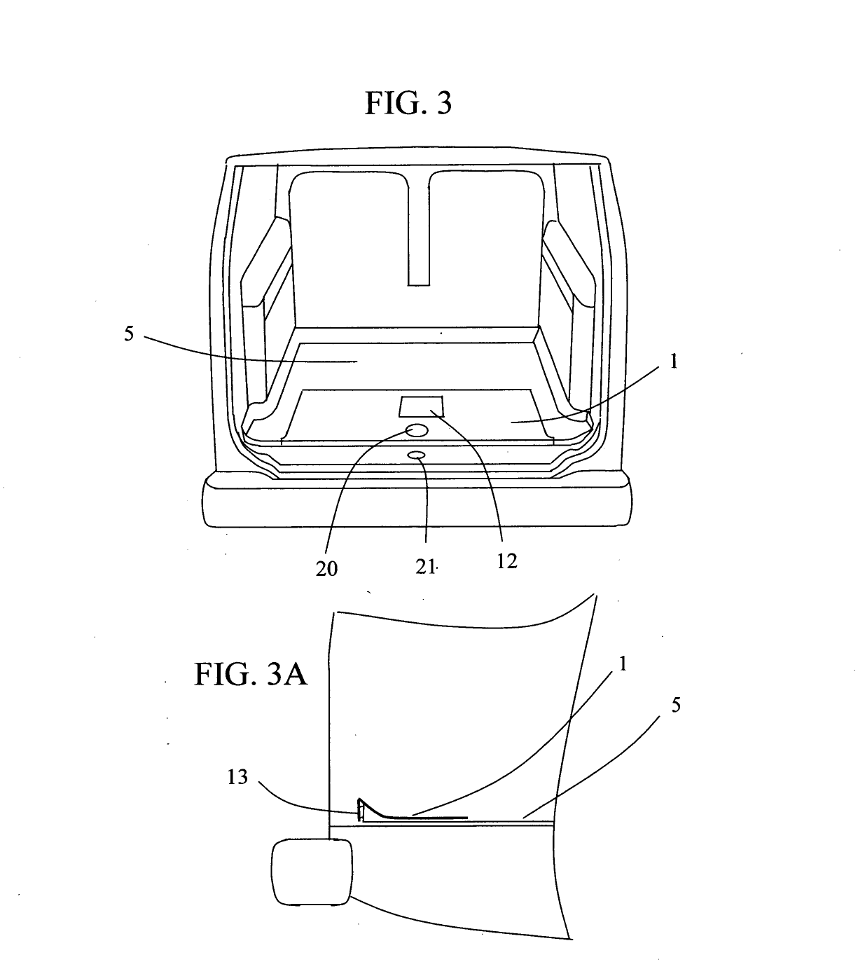

FIG. 3 shows the view through the open cargo door of a vehicle equipped with a deployable pad for vehicle bumper and tailgate protection (1). The deployable pad for vehicle bumper and tailgate protection is attached to the rear vertical wall of the cargo area liner (5). The optional advisory label (12) saying something such as “Please open the bumper protection pad before loading cargo” is also depicted. This label is especially important if persons other than the vehicle owner or operator sometimes load cargo in the cargo area.

An additional minor embodiment of the invention is also depicted in FIG. 3. A door latch clearance hole (20) can be added to allow the door latch mechanism (21) to function if the cargo access door is closed over the deployable pad for vehicle bumper and tailgate protection (1).

If desired, the deployable pad can be made to compliment the design and finish of the vehicle cargo area liner by either constructing it from the same material used for the liner or constructing a one piece integrated assembly consisting of a cargo area liner and a deployable pad.

FIG. 3A is a cross sectional side view illustrating how the deployable pad for vehicle bumper and tailgate protection (1) rests within the cargo area liner (5) when it is “retracted”. The adhesive connection between the deployable pad for vehicle bumper and tailgate protection and the cargo area liner (13) is shown on the outside of the vertical surface. The connection point (13) can also be on the inside surface.

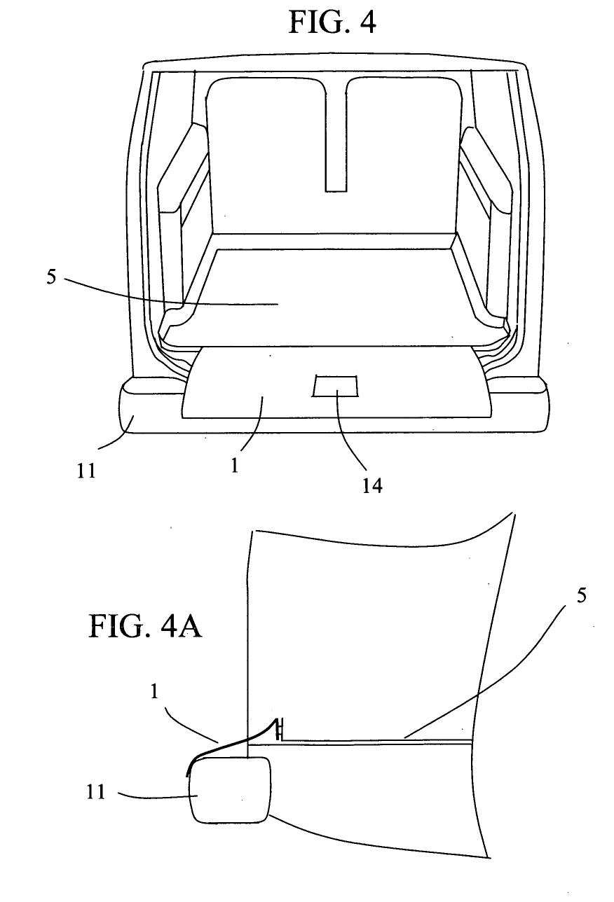

FIG. 4 shows the deployable pad for vehicle bumper and tailgate protection (1) in its' deployed position. While the length of the pad varies, the most important design point is to ensure that the whole top and some portion of the rear face of the bumper (11) are protected. Te optional warning label (14) should advise the cargo handler to retract or close the deployable pad before closing the cargo door.

FIG. 4A is a cross section view from the side of a vehicle with a deployable pad for vehicle bumper and tailgate protection (1) affixed to a cargo area liner (5) as it appears in the deployed position which covers and protects the vehicle rear bumper (11).

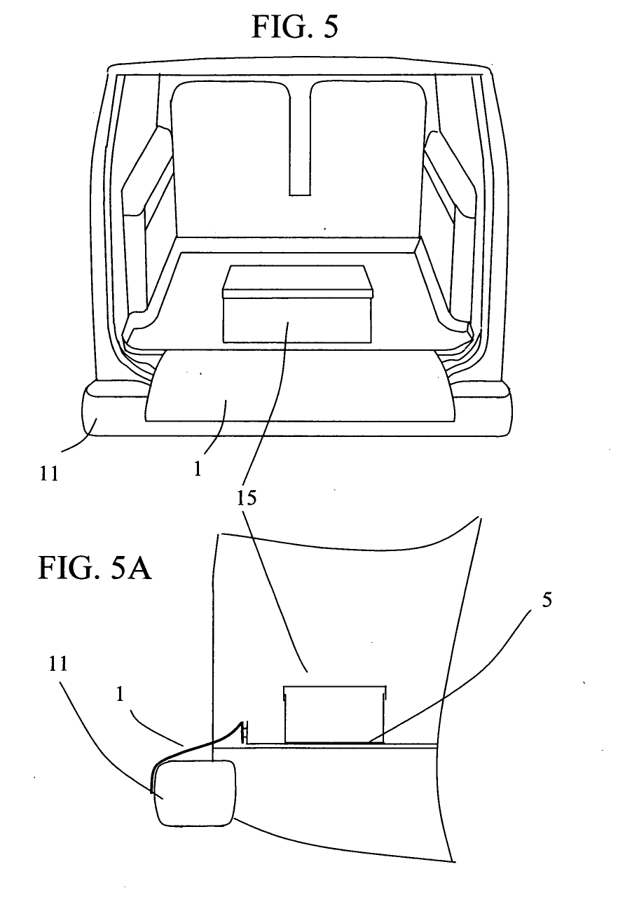

FIGS. 5 and 5A are views illustrating the relationship of cargo (15) placed in the cargo area atop the cargo area liner (5) with the deployable pad (1) covering the rear vehicle bumper (11).

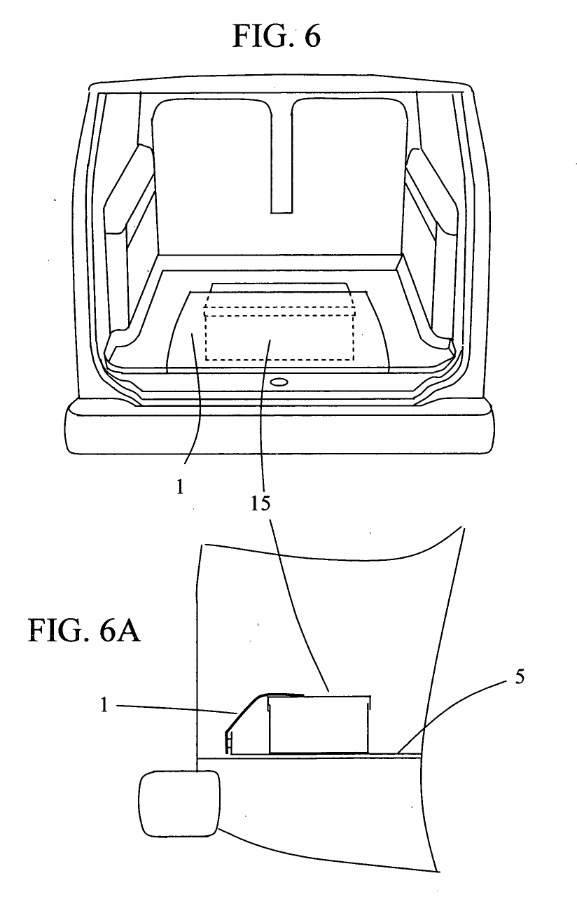

FIGS. 6 and 6A are views illustrating cargo (15) placed within the cargo area. Note that cargo (15) positioned close to the rear of the cargo area liner (5) forces the deployable pad (1) to remain in a somewhat vertical position between the rear cargo door and the cargo. This deployable pad position is intended to eliminate or reduce inadvertent damage to the decorative finish of the rear cargo door when the load shifts due to vehicle motion.

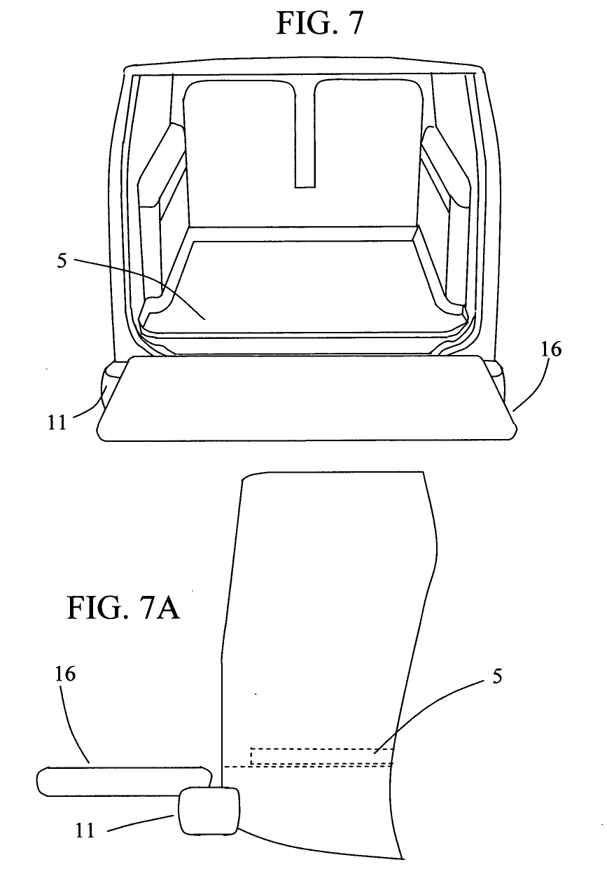

FIGS. 7 and 7A are views illustrating another common configuration for light vehicles with a rear cargo area. The configuration pictured is a split rear access, which has a downward opening rear tailgate (16). The inside surface of downward opening tailgates is typically finished with combinations of decorative plastic, leather and paint which are susceptible to being damaged when cargo is loaded or off-loaded. A rear cargo area liner (5) is depicted as this configuration of vehicle can be used with a cargo liner or cargo may be placed directly upon the floor as is the case with single door vehicles. The downward opening tailgate (16) protects the rear bumper (11) from accidental damage. Thus the sole purpose of the deployable pad for vehicle bumper and tailgate protection in this configuration is to protect the inner (16) surface of the downward opening tailgate (16).

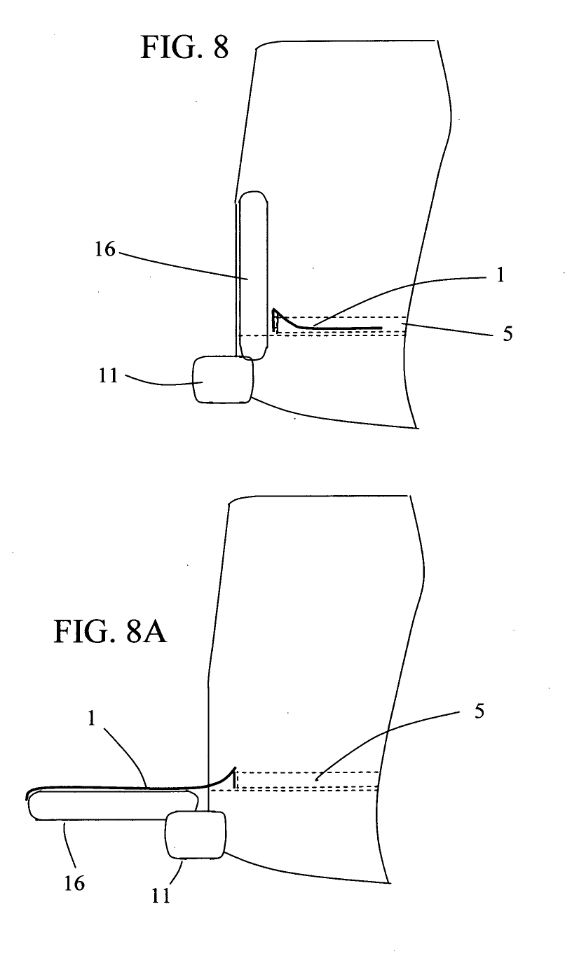

FIG. 8 is a cross section view from the side of a downward opening tailgate (16) vehicle equipped with a deployable pad for vehicle bumper and tailgate protection (1) attached to a cargo area liner in the retracted or stored position.

FIG. 8A is a cross section view from the side of a downward opening tailgate (16) vehicle equipped with a deployable pad for vehicle bumper and tailgate protection (1) attached to a cargo area liner in the deployed or extended position.

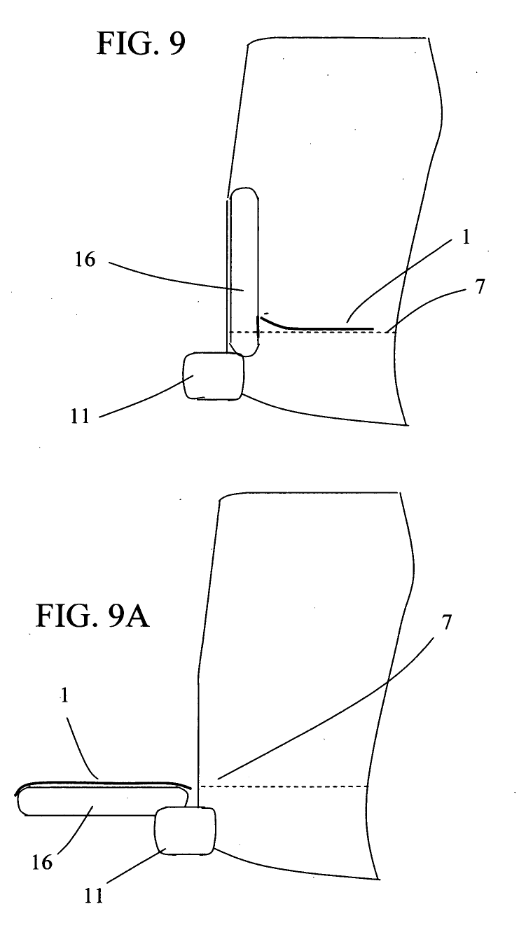

FIG. 9 is a cross section view from the side of a downward opening tailgate (16) vehicle equipped with a deployable pad for vehicle bumper and tailgate protection (1) attached to the downward opening tailgate in the retracted position.

FIG. 9A is a cross section view from the side of a downward opening tailgate (16) vehicle equipped with a deployable pad for vehicle bumper and tailgate protection (1) attached to the downward opening tailgate (16) in the deployed position. An option to attaching the deployable pad (1) to the inside surface of the downward opening tailgate (16) is to attach it to the rearmost portion of the cargo area floor (8).

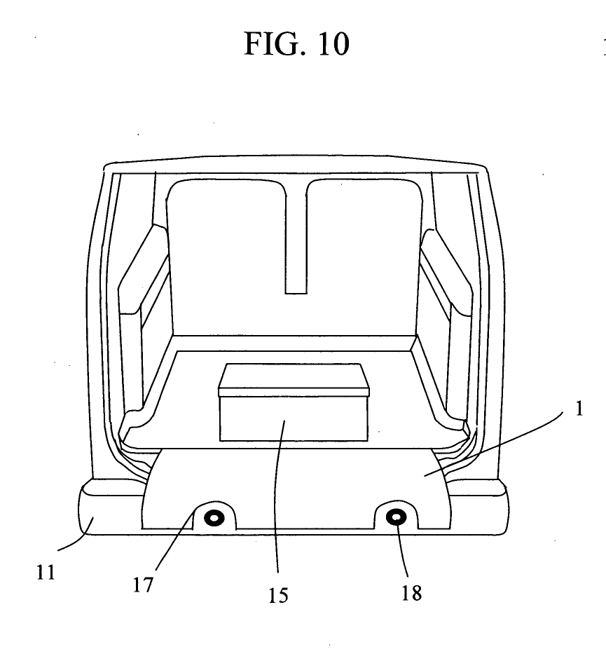

FIG. 10 is a perspective view illustrating a vehicle with ultrasonic parking assistance, which emits an audible alarm when an obstacle behind the vehicle reflects ultrasonic sound waves to the transponders (18). When the deployable pad for vehicle bumper and tailgate protection (1) is in the deployed position it can cause interference with the transponders when they are placed too high within the bumper (11). A false alarm condition will be generated if the vehicle is moved with the deployable pad (1) in the deployed position, which can block the transponders (18). A false alarm is dangerous as it negates the operation of the system since the operator will disregard a true alarm condition. The resolution for the previously described circumstance is to provide openings (17) within the deployable pad (1) to ensure no interference with the transponders (18).

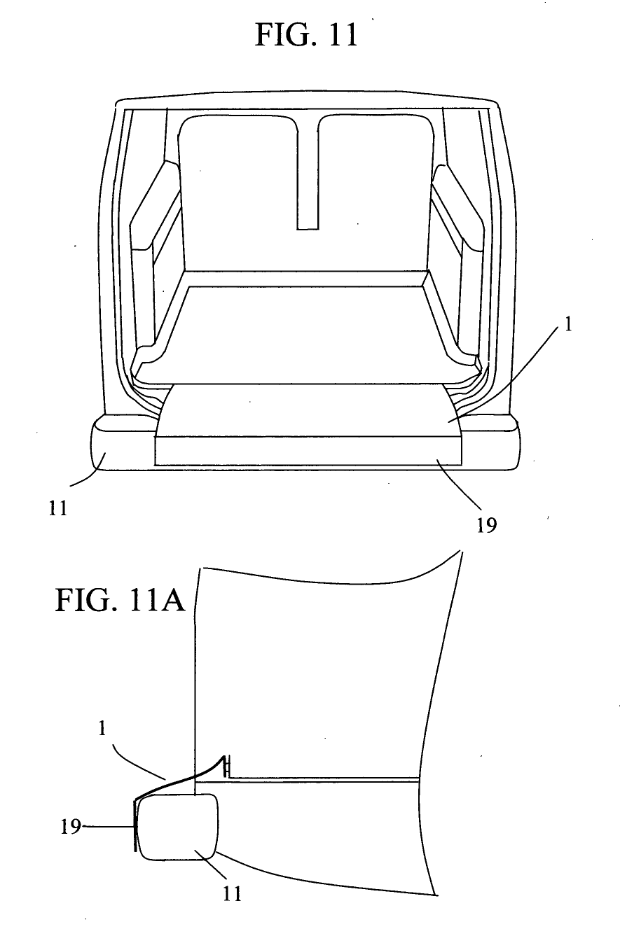

FIGS. 11 and 11A represent another embodiment of the invention used to provide additional protection for the vertical surface of a decorative bumper (11). This embodiment of the deployable pad (1) utilizes a re-enforced element (19) that can protect the bumper from being scratched, dented or punctured in the case of rubber covered bumpers when light contact is made with a trailer tongue during attachment or detachment of said trailer. The re-enforcing element can be manufactured from various materials including metal, plastic, and composites.

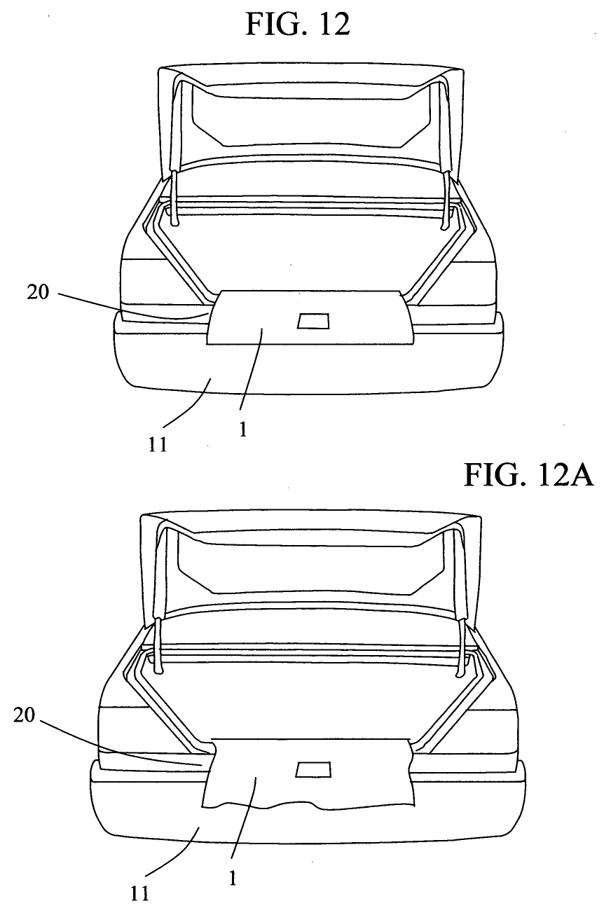

FIG. 12 illustrates another embodiment of the deployable pad for vehicle bumper and tailgate protection (1) as used to protect an automobile trunk sill and decorative bumper. The deployable pad for vehicle bumper and tailgate protection (1) is shown in a deployed position. The deployed position results in the pad being draped over vehicle rear bumper (11) and the trunk sill (20). The deployable pad can be affixed to the inside face of the trunk sill, the trunk floor or a trunk floor liner. Attachment methods include adhesives, mechanical fasteners, double-sided tape or hook and loop fasteners. A similar embodiment is realized when the deployable pad for vehicle bumper and tailgate protection (1) is used to protect the rear bumper on station wagons with rear cargo areas or rear facing third seats.

FIG. 12A illustrates an alternative embodiment of the deployable pad for vehicle bumper and tailgate protection made of a flexible material such as cloth, soft vinyl, imitation leather or other supple materials (1) as used to protect an automobile trunk lid and decorative bumper with the trunk opening being curved in one or more planes. The deployable pad for vehicle bumper and tailgate protection (1) is shown in a deployed position. The deployed position results in the pad being draped over vehicle rear bumper (11) and the trunk sill (20). The deployable pad can be affixed to the inside face of the trunk sill, the trunk floor or a trunk floor liner. Attachment methods include adhesives, mechanical fasteners, double-sided tape or hook and loop fasteners. This embodiment is particularly suited to applications consisting of curved openings that do not suit themselves to hinged devices utilizing rigid or semi-rigid materials that do not allow the material to conform to the shape of the trunk opening.

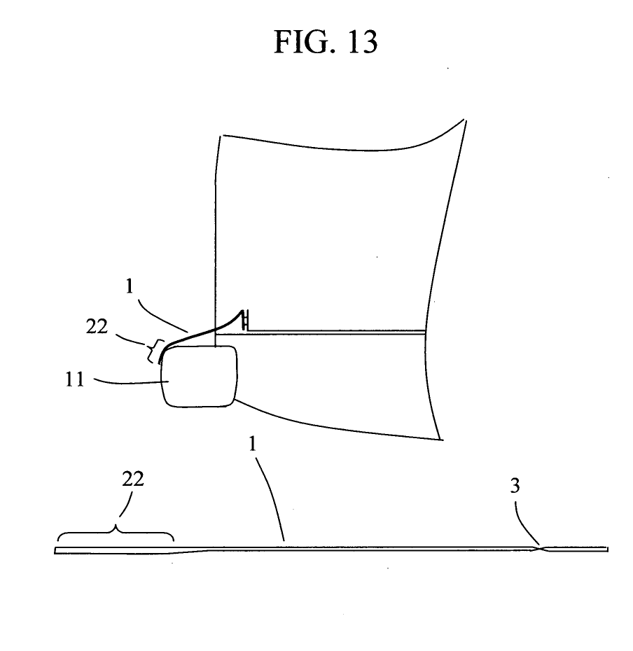

FIG. 13 illustrates the embodiment of varying the cross sectional thickness of the deployable pad (1). In this instance, the portion of the pad (22) that would be positioned adjacent to the rear bumper (1) has been extruded with a thicker cross section than the average cross section of the pad. This thickening increases the strength and resistance to damage and adds additional weight to help stabilize the deployable pad. In certain instances it may be desirable to increase the cross sectional thickness in the area of the living hinge (3) for additional strength.

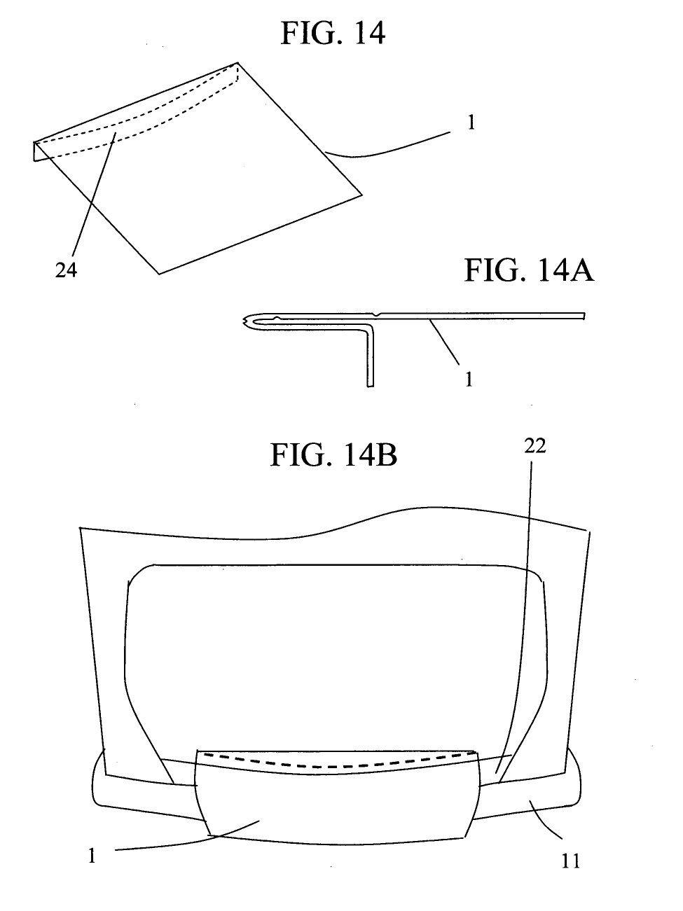

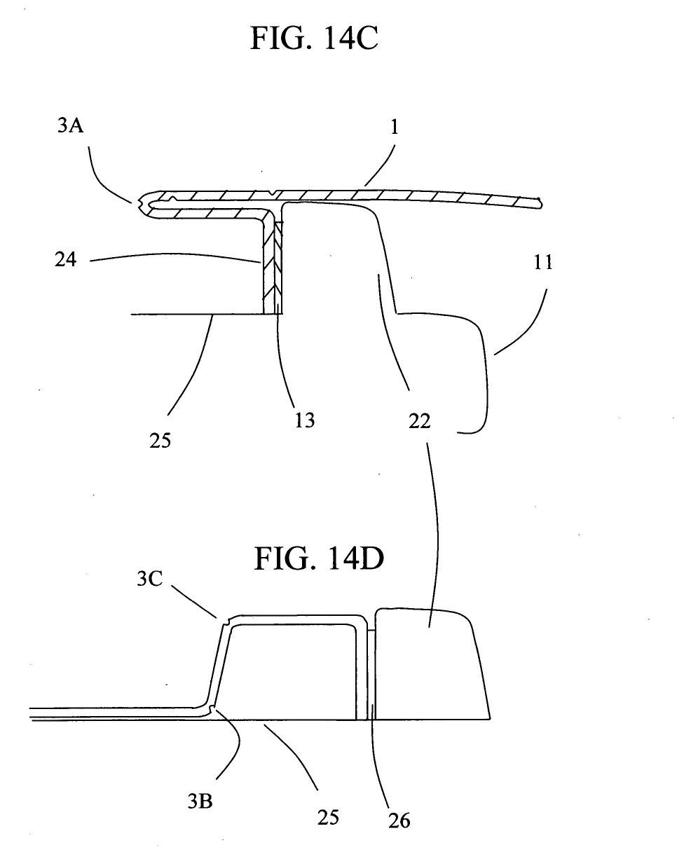

FIG. 14 illustrates an embodiment of a deployable pad for vehicle bumper and tailgate protection (1) that is designed to attach to a curved trunk sill. This embodiment is necessary to allow the use of a hinge to move the pad (1) from the deployed to the retracted position. The preferable method of manufacture for the deployable pad assembly would be blow molding. The curved vertical plane (23) would be custom fitted to specific automobiles or families of automobiles. The vertical plane (23) is intended to attach to the rear surface of the automobile trunk utilizing adhesives, mechanical fasteners, double-sided tape or hook and loop fasteners.

FIG. 14A shows a cross section of the deployable pad for vehicle bumper and tailgate protection (1) that is designed to attach to a curved trunk sill. The distance from the vertical plane (24) is at its' maximum in the center of the pad (1) and diminishes to 0 inches at the sides of the pad.

FIG. 14B is a top view illustrating an automobile trunk area with a deployable pad for vehicle bumper and tailgate protection (1) installed. The pad (1) is shown in the deployed position that protects the vehicle bumper (11) and trunk sill (22).

FIG. 14C is a cross sectional view of the middle of the deployed protection pad (1), the trunk sill (22) and floor (25). Also illustrated is the adhesive (13) used to attach the vertical plane (24) to the trunk sill (22). Living hinge 3A allows the main body of the deployable pad for vehicle bumper and tailgate protection (1) to pivot to the rear of the vehicle. When the pad is pivoted to the rear of the vehicle in what is referred to as the deployed position it drapes over the vehicle bumper (11) and trunk sill (22).

FIG. 14D is a cross sectional view of the middle of the retracted protection pad (1), the trunk sill (22) and trunk floor (25). Living hinges 3B and 3C allow the retracted pad (1) to fold to the trunk floor (25) with a minimum amount of lost space in the trunk.

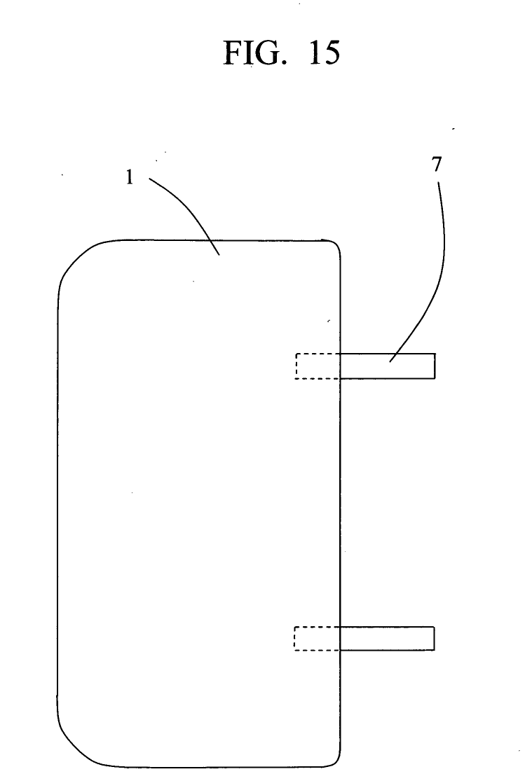

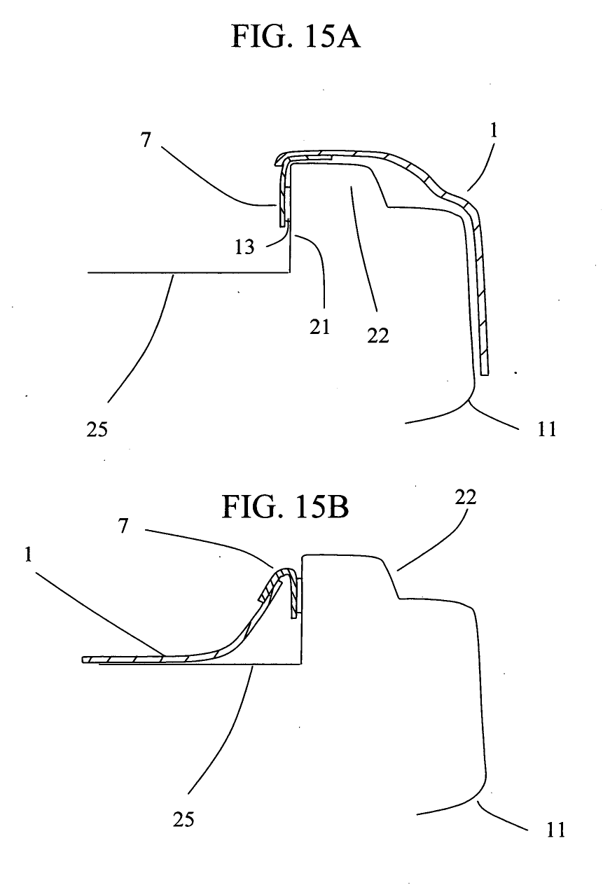

FIG. 15 is a top view of the embodiment of the deployable pad (1) that can be attached to a trunk sill or the floor of a cargo area by using attached mounting straps (7). The straps (7) can be attached to the pad (1) by stitching, gluing or mechanical fasteners. The straps can be attached to the appropriate automotive surface in a removable or a permanent fashion. Temporary or removable attachment processes include hook and loop fastening strips whereby one of the strips could be sewn or glued to the attachment strip. An additional temporary or removable attachment method is to use double sided tape or mechanical snaps.

More permanent methods of attachment can be accomplished by using mechanical fasteners such as screws or various types of push fasteners currently used to upholster and attach interior panels in the automotive industry.

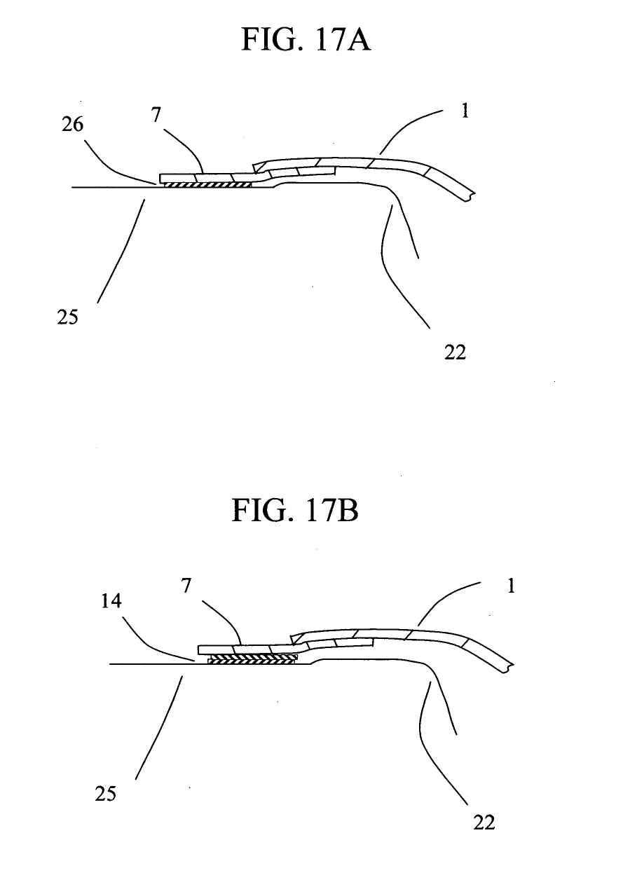

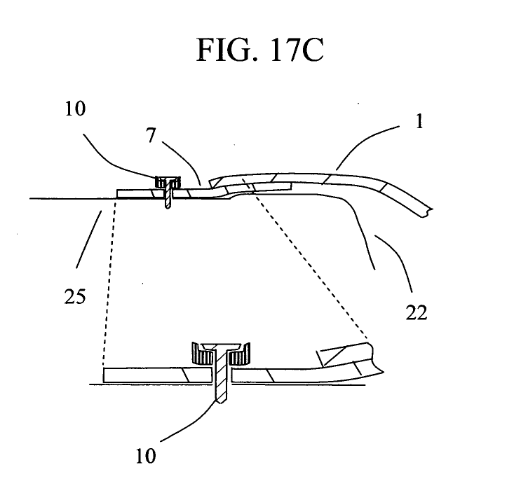

FIG. 15A is a cross sectional view illustrating how a deployable pad (1) installed in an automotive trunk and attached with mounting straps (7) appears when deployed or extended over the trunk sill (22) and the rear bumper (11). The mounting straps (7) can be attached in a multitude of ways. In this representation, double sided adhesive tape (22) is shown as an attachment method used to affix the strap (7) to the rear interior trunk wall (21). FIGS. 17A, B and C represent the details of the 3 basic attachment methods. Mounting straps (7) are flexible and will conform to any contour presented by an automotive trunk wall, the trunk sill and the rear bumper. In some instances an automotive trunk lacks a rear inner wall. In these instances, the mounting straps (7) can be affixed to the trunk floor or spare tire cover.

FIG. 15B is a cross sectional view illustrating how a deployable pad (1) attached with mounting straps (7) appears when retracted or placed within the automotive trunk area. When the trunk is empty the pad (1) lies on the trunk floor (25). If the pad (1) is deployed and cargo added to the trunk area the pad can be folded to fit between the cargo and the rear trunk wall or laid on top of the added cargo.

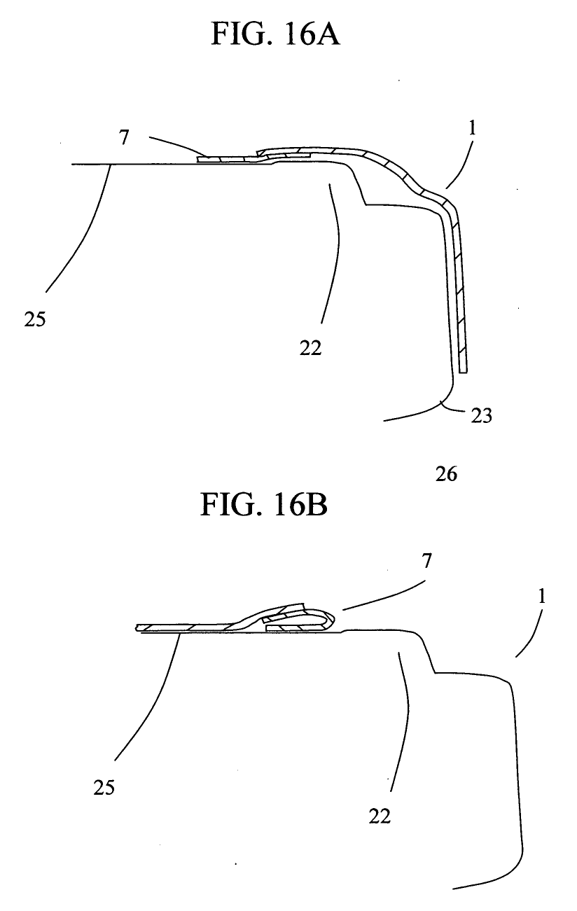

FIG. 16A is a cross sectional view illustrating how a deployable pad (1) installed in the typical SUV cargo area and attached with mounting straps (7) appears when deployed or extended over the cargo area sill (22) and the rear bumper (11). The mounting straps (7) can be attached in a multitude of ways. Mounting straps (7) are flexible and will conform to any contour presented by a SUV cargo area floor, cargo area sill and the rear bumper.

FIG. 16B is a cross sectional view illustrating how a deployable pad (1) installed in the typical SUV cargo area and attached with mounting straps (7) appears when retracted or placed within the SUV cargo area. The mounting straps (7) can be attached in a multitude of ways.

FIG. 17A is a cross sectional view depicting a deployable pad for vehicle tailgate and bumper protection (1) possessing a multitude of mounting straps (7) that are affixed to the vehicle cargo area floor (25) with an adhesive (26). The adhesive (13) can be a dispensable adhesive o it can be strips of 2-sdided tape. In this drawing, the deployable pad (1) is extended over the vehicle cargo area sill (22).

FIG. 17B is a cross sectional view depicting a deployable pad for vehicle tailgate and bumper protection (1) possessing a multitude of mounting straps (7) that are affixed to the vehicle cargo area floor (25) using hook and loop fasteners (14). In this drawing, the deployable pad (1) is extended over the vehicle cargo area sill (22).

FIG. 17C is a cross sectional view depicting a deployable pad for vehicle tailgate and bumper protection (1) possessing a multitude of mounting straps (7) that are affixed to the vehicle cargo area floor (25) using mechanical fasteners (10). The fasteners can be a multitude of types including sheet metal screws, rivets, push in Christmas tree fasteners and others. In this drawing, the deployable pad (1) is extended over the vehicle cargo area sill (22).

Although preferred embodiments of the method and apparatus of the present invention has been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the included claims.

Materials suitable for various embellishments of the protection pad include but are not limited to: cloth, felt, vinyl, carpet, flexible plastics and laminated combinations thereof. The protection pad can be attached to the receiving vehicle with permanent adhesives, two sided tape, hook and loop fasteners and mechanical fasteners such as rivets, screws, or upholstery fasteners. The protection pad edge can be enhanced by the addition of stitched or adhesively affixed edging.

Operational characteristics such as flexibility, stiffness and durability of the deployable pad can be influenced and altered by material selection.

What is claimed is:

1. A deployable, flexible rear bumper protection pad for vehicle rear bumpers affixed to a removable cargo area liner for certain vehicles that utilize a rear cargo door, hatch or tailgate comprising;
a flexible flap being the same width as the bottom of the door opening or slightly smaller and affixed to the back of a removable cargo area liner
the flexible flap having a depth sufficient to cover the top surfaces of a painted rear bumper when it is deployed through the door opening
the deployable vehicle rear bumper protector pad is comprised of the same or similar material as the cargo area liner to which it is attached or is a part and extension thereof
the deployable vehicle rear bumper protector pad folds forward onto the bottom of the cargo area liner when the rear cargo door is closed and is constructed of flexible plastic, carpet, cloth, rubber or a laminated combination of any of the aforementioned materials

2. A deployable, flexible rear bumper protection pad for vehicle rear bumpers attached to a removable cargo area liner for certain vehicles utilizing cargo trunks comprising;
a flexible flap being the same width as the bottom of the door opening or slightly smaller and attached to the back of a removable cargo area liner
the flexible flap having a depth sufficient to cover the top surfaces of a painted rear bumper when it is deployed through the trunk opening
the deployable vehicle rear bumper protector pad is comprised of the same or similar material as the cargo area liner to which it is attached or is a part and extension thereof
the deployable vehicle rear bumper protector pad folds forward onto the trunk floor when the trunk is closed and is constructed of flexible plastic, carpet, cloth, rubber or a laminated combination of any of the aforementioned materials

3. A deployable, flexible rear bumper protection pad for vehicle rear bumpers that is attachable directly to the rearmost portion of the cargo area or trunk floor for certain vehicles that utilize a rear cargo door, hatch, tailgate or trunk comprising:
a flexible flap being the same width as the bottom of the access opening or slightly smaller and attached to the cargo area or trunk floor using mechanical fasteners, adhesives, double sided tape or hook and loop fasteners.
the flexible flap having a depth sufficient to cover the top surfaces of a painted rear bumper when it is deployed through the access opening
the deployable vehicle rear bumper protector pad is comprised of a flexible plastic, carpet, or rubber material, or a laminated combination of the aforementioned materials.
the deployable vehicle rear bumper protector pad folds forward onto the cargo area or trunk floor when the access door or trunk lid is closed and is constructed of flexible plastic, carpet, cloth, rubber or a laminated combination of any of the aforementioned materials

4. A deployable, flexible rear bumper protection pad for vehicle rear bumpers that is attached by mounting straps to the rearmost portion of the cargo area floor for certain vehicles utilizing a rear cargo door, hatch, tailgate or trunk comprising:
a flexible flap being the same width as the bottom of the access opening or slightly smaller and attached to the cargo area or trunk floor with straps that attach using mechanical fasteners, adhesives, double sided tape or hook and loop fasteners.
the flexible flap having a depth sufficient to cover the top surfaces of a painted rear bumper when it is deployed through the door opening
the deployable vehicle rear bumper protector pad is comprised of a flexible plastic, carpet, or rubber material, or a laminated combination of the aforementioned materials.
the deployable vehicle rear bumper protector pad folds forward onto the cargo area or trunk floor when the access door or trunk lid is closed and is constructed of flexible plastic, carpet, cloth, rubber or a laminated combination of any of the aforementioned materials

5. A deployable, flexible rear bumper protection pad for vehicle rear bumpers that is directly attachable to the rear wall of the trunk area for certain vehicles comprising:
a flexible flap being the same width as the bottom of the access door or trunk lid opening or slightly smaller and attached to the rear trunk wall using mechanical fasteners, adhesives, double sided tape or hook and loop fasteners.
the flexible flap having a depth sufficient to cover the top surfaces of a painted rear bumper when it is deployed through the access door or trunk lid opening
the deployable vehicle rear bumper protector pad is comprised of a flexible plastic, carpet, or rubber material, or a laminated combination of the aforementioned materials
the deployable vehicle rear bumper protector pad folds forward onto the trunk floor when the access door or trunk lid is closed and is constructed of flexible plastic, carpet, cloth, rubber or a laminated combination of any of the aforementioned materials

6. A deployable, flexible rear bumper protection pad for vehicle rear bumpers that is attached by mounting straps to the rear wall of the trunk area for certain vehicles comprising:
a flexible flap being the same width as the bottom of the access door or trunk lid opening or slightly smaller and attached to the rear trunk wall using mechanical fasteners, adhesives, double sided tape or hook and loop fasteners.
the flexible flap having a depth sufficient to cover the top surfaces of a painted rear bumper when it is deployed through the access door or trunk lid opening
the deployable vehicle rear bumper protector pad is comprised of a flexible plastic, carpet, or rubber material, or a laminated combination of the aforementioned materials
the deployable vehicle rear bumper protector pad folds forward onto the trunk floor when the access door or trunk lid is closed and is constructed of flexible plastic, carpet, cloth, rubber or a laminated combination of any of the aforementioned materials

7. An advisory label positioned on the deployable pad for vehicle bumper and tailgate protection alerting cargo handlers to open the pad prior to loading.

8. A warning label positioned on the deployable pad for vehicle bumper and tailgate protection alerting cargo handlers to fold the pad forward prior to closing the cargo door.

9. Use of the deployable pad for vehicle bumper and tailgate protection device to protect the decorative inner lining of closed rear cargo doors or tailgates.

10. An opening within the deployable pad for vehicle bumper and tailgate protection to allow the door latching mechanism to function.

11. Adding weight to the deployable rear bumper protection pad for vehicle rear bumpers to keep it stabilized in the deployed position.

12. Provision of openings to allow back-up assistance systems to function.

13. Re-enforcing the deployable pad for vehicle bumper and tailgate protection to protect against towable trailer and other contact damage.

14. A mechanical fastener to stabilize the deployable pad for vehicle bumper and tailgate protection so that the pad remains in the deployed position.

15. The use of a hook and loop fastener to stabilize the deployable pad for vehicle bumper and tailgate protection so that the pad remains in the deployed position.

16. The use of a multitude of pad thicknesses to vary said pads properties by area.

17. A method of hinging a rigid or semi-rigid deployable rear bumper protection pad from a non-linear or curved surface.

18. A method of disguising the appearance of the deployable rear bumper protection pad from a non-linear or curved surface comprising;
finishing the underside of the deployable pad with the same material used for the cargo area or vehicle trunk door surface
